(19) United States
(12) Patent Application Publication
(10) Pub. No.: US 2021/0333462 A1
(43) Pub. Date: Oct. 28, 2021

(54) LIGHT GUIDE PLATE AND BACKLIGHT MODULE

(71) Applicant: WUHAN CHINA STAR OPTOELECTRONICS TECHNOLOGY CO., Wuhan, Hubei (CN)

(72) Inventors: Liqiong QIAN, Wuhan, Hubei (CN); Xindong MEI, Wuhan, Hubei (CN)

(21) Appl. No.: 16/494,840

(22) PCT Filed: May 22, 2019
(86) PCT No.: PCT/CN2019/087970

§ 371 Date: Sep. 17, 2019

(30) Foreign Application Priority Data
Mar. 28, 2019 (CN) 201910243859.8

(51) Int. Cl. F21V 8/00

(52) U.S. Cl. CPC G02B 6/0045; G02B 6/0041; G02B 6/009

(57) ABSTRACT

A light guide plate includes a light guide body and a through hole. The light guide body further includes a first light exit surface. The first light exit surface is a side wall surrounding the through hole and is a shaped surface. An embodiment of the shaped surface can be an inclined plane, a quadric surface, or a free curved surface. After guiding the lights emitted from the light source by the light guide plate, more lights enter the through hole and the through hole area of the display panel. Furthermore, the first light exit surface can be adjusted to ensure the uniformity of the brightness in a display area.

### FIELD OF INVENTION

The present disclosure relates to a display technology, and particularly relates to a light guide plate and a backlight module.

### BACKGROUND OF INVENTION

In recent years, with rapid development of intelligent display device, especially with rapid development of the mobile phones and other mobile devices, screen size and screen-to-body ratio of display panels of the mobile devices have become larger.

However, for the mobile phones, a complete transformation from narrow frame displays to full screen displays has not been realized yet due to arrangements of a camera and a microphone of the mobile phone. For increasing the screen-to-body ratio, overcoming the low transparency of the conventional light guide plate, and achieving a transparent display in the camera area of a mobile phone, one current method is a drilling technique, namely, drilling a hole on the area of a camera module. The drilling technique can solve the problem of the low transparency in the camera area. However, since a portion of film layer of the module is removed by drilling, the display brightness decreases, a transparent display cannot be achieved, and the display quality also decreases in the drilled area when the screen works, which affect user experience.

Therefore, to provide a solution for solving the problems of the conventional technology is required.

In summary, the conventional display module has some problems should be solved when proceeding the drilling process, such as the decreases of the display brightness and the display quality in the drilled area, and the low transparency of the conventional light guide plate of the module. The conventional display module needs further improvement.

### SUMMARY OF INVENTION

For solving the above problems, the present disclosure provides a light guide plate and a backlight module to solve the problems in conventional technology, that is, a transparent display can't be achieved in camera area, and the display brightness and the display quality decrease.

For solving the above problems, the technical solutions provided by an embodiment of the present disclosure are as follows:

According to a first aspect of an embodiment of the present disclosure, the present disclosure provides a light guide plate including a light guide body and a through hole disposed on the light guide body. The light guide body includes a first light exit surface. The first light exit surface is a side wall surrounding the through hole, and the first light exit surface is a shaped surface. The shaped surface is a quadric surface. A curvature of an upper end of the quadric surface is greater than a curvature of a lower end of the quadric surface.

According to an embodiment of the present disclosure, the through hole is a tapered hole, and a cross section of the first light exit surface is an inclined plane.

According to an embodiment of the present disclosure, the shaped surface is a free curved surface, and the free curved surface is a convex-concave curved surface.

According to an embodiment of the present disclosure, the shaped surface is a quadric surface, and curvatures along the side wall of the quadric surface are different from upper to bottom.

According to an embodiment of the present disclosure, the light guide plate further includes a plurality of particles. The particles are transparent silica particles, and the particles are disposed in the light guide plate.

According to an embodiment of the present disclosure, the light guide plate further includes a camera device, and the camera device is disposed in the through hole.

According to an embodiment of the present disclosure, a height of the camera device is not greater than a height of the through hole.

According to a second aspect of an embodiment of the present disclosure, the present disclosure further provides a light guide plate including a light guide body and a through hole disposed on the light guide body. The light guide body includes a first light exit surface. The first light exit surface is a side wall surrounding the through hole, and the first light exit surface is a shaped surface.

According to an embodiment of the present disclosure, the through hole is a tapered hole, and a cross section of the first light exit surface is an inclined plane.

According to an embodiment of the present disclosure, the shaped surface is a free curved surface, and the free curved surface is a convex-concave curved surface.

According to an embodiment of the present disclosure, the shaped surface is a quadric surface, and curvatures along the side wall of the quadric surface are different from upper to bottom.

According to an embodiment of the present disclosure, the light guide plate further includes a plurality of particles. The particles are transparent silica particles, and the particles are disposed in the light guide body.

According to a third aspect of an embodiment of the present disclosure, the present disclosure provides a backlight module including: a light guide plate, wherein the light guide plate includes a light guide body and a through hole, and the through hole is disposed on the light guide body; an optical film disposed on the light guide plate; a display screen disposed on the optical film; a light source; and a frame body. The light source is disposed on a side of the frame body and used for providing a light source for the light guide plate. The frame body is disposed outside the light guide plate and for fixing the light guide plate. The light guide body includes a first light exit surface. The first light exit surface is a side wall surrounding the through hole, and the first light exit surface is a shaped surface.

According to an embodiment of the present disclosure, the display screen includes a first display area and a second display area. The first display area is disposed adjacent to the second display area. The through hole is disposed in the first display area.

According to an embodiment of the present disclosure, the backlight module further includes a camera device, and the camera device is disposed in the through hole.

According to an embodiment of the present disclosure, a height of the camera device is not greater than a height of the through hole.

According to an embodiment of the present disclosure, the through hole is a tapered hole, and a cross section of the first light exit surface is an inclined plane.

According to an embodiment of the present disclosure, the shaped surface is a free curved surface, and the free curved surface is a convex-concave curved surface.

According to an embodiment of the present disclosure, the shaped surface is a quadric surface, and curvatures along the side wall of the quadric surface are different from upper to bottom.

According to an embodiment of the present disclosure, the backlight module further includes a plurality of particles. The particles are transparent silica particles, and the particles are disposed in the light guide body.

In summary, advantageous effects of an embodiment of the present disclosure:

The present disclosure provides a new structure of a light guide plate, a backlight module, and a display panel. When the camera disposed on the display panel doesn't work, the display area corresponding to the camera area can achieve a transparent display, and the display brightness of the drilled area doesn't decrease, which are favorable for achieving a narrow frame design and increasing the screen-to-body ratio and the display quality of the display panel.

### DESCRIPTION OF DRAWINGS

FIG. 1 is a schematic diagram of the drilled area according to the current design of a mobile phone.

FIG. 2 is a schematic diagram of a backlight module according to an embodiment of the present disclosure.

FIG. 3 is a schematic diagram of the propagation of light in a backlight module according to an embodiment of the present disclosure.

FIG. 4 is a schematic structure of a light guide plate according to an embodiment of the present disclosure.

FIG. 5 is a schematic structure of a further light guide plate according to an embodiment of the present disclosure.

FIG. 6 is a schematic structure of a light guide plate according to another embodiment of the present disclosure.

FIG. 7 is a schematic diagram of a display device according to an embodiment of the present disclosure.

### DETAILED DESCRIPTION OF PREFERRED EMBODIMENTS

The following embodiments with reference to the attached drawings, for the particular embodiment used to illustrate embodiments of the present invention. Further, according to the direction of the mentioned invention, such as upper, lower, top, bottom, front, rear, left, right, inner, outer, side, around a central, horizontal, lateral, vertical, longitudinal, axial, radially, the uppermost layer or the lowermost layer, etc., are only with reference to the attached figures direction. Thus, the use of directional terms are used to describe and understand the present invention, not to limit the present invention.

With the continuous development of the performance of the mobile phone, people's requirements for the performance of the display screen of the mobile phone also increase, for example, higher screen-to-body ratio and higher display quality. For increasing the screen-to-body ratio, almost every area of the front display screen of the mobile phone performs the display function is required. However, for proceeding the drilling technique, the module is drilled to dispose a camera in the through hole. In the drilled area, the transparency is usually low, and the display quality is usually not satisfactory.

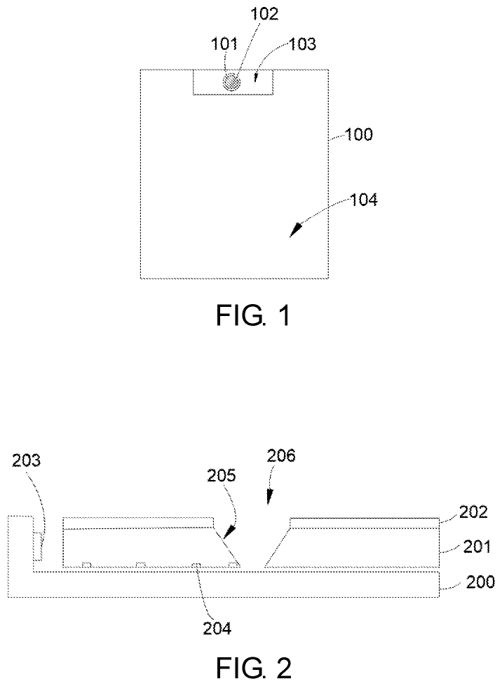

In an embodiment of the present disclosure, specifically, as shown in FIG. 1, FIG. 1 is a schematic diagram of the drilled area according to the current design of a mobile phone. A display screen 100 includes: a first display area 103, a second display area 104, a through hole 101, and a camera device 102. The first display area 103 is disposed adjacent to the second display area 104. The first display area 103 is the drilled area. For designing an attractive screen, the first display area 103 can be disposed on an end portion of the display screen of the mobile phone, or the first display area 103 can be disposed on the area near a side frame, which is more beneficial to achieve the full screen display. The camera device 102 can be disposed in the through hole 101, and a height of the camera device 102 is not greater than a height of the through hole 101.

For solving the problems of display in the first display area 103, an embodiment of the present disclosure provides a new backlight module. Specifically, as shown in FIG. 2, FIG. 2 is a schematic diagram of a backlight module according to an embodiment of the present disclosure. The backlight module includes a frame body 200, a light guide plate 201, an optical film 202, and a light source 203. The optical film 202 is disposed on the light guide plate 201. The light source 203 is disposed on a side of the frame body 200 to make the mobile phone lighter and thinner. The light source 203 provides a light source for the backlight module. The frame body 200 is disposed outside the light guide plate 201 and for fixing the light guide plate 201 and other components.

The backlight module further includes a through hole 206 and a first light exit surface 205. The first light exit surface 205 is a side wall surrounding the through hole 206. The through hole 206 is disposed on the light guide plate 201. For the optical film 202, the area corresponding to the position of the through hole 206 is also drilled to dispose a camera device. The first light exit surface 205 is a shaped surface.

The backlight module according to an embodiment of the present disclosure further includes a plurality of particles 204. The particles 204 are disposed in the light guide plate 201, specifically close to the lower end surface of the light guide plate 201. The particles 204 can reflect or scatter the lights incident to the lower end surface of the light guide plate 201, and change the propagating path of light to guide as more as possible lights into the through hole 206 area of the light guide plate 201, which increases the brightness of the through hole 206 area, namely the brightness of the first display area, to increase the display quality in the first display area.

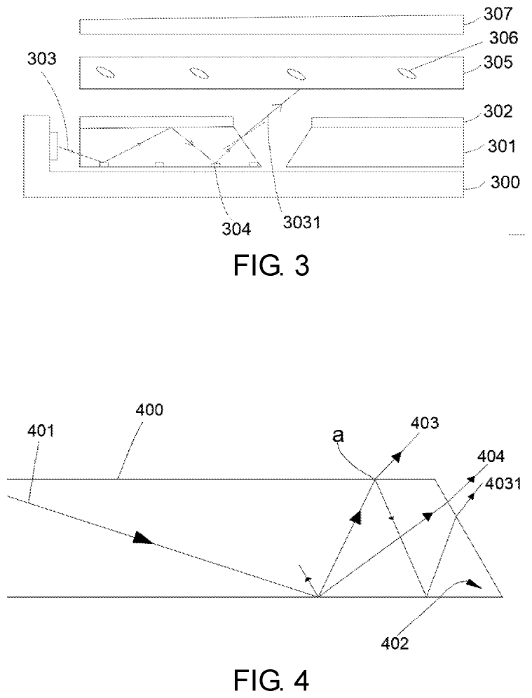

Specifically, as shown in FIG. 3, FIG. 3 is a schematic diagram of the propagation of light in a backlight module according to an embodiment of the present disclosure. The backlight module according to an embodiment of the present disclosure includes a frame body 300, a light guide plate 301, an optical film 302, a display screen 305, and a cover glass 307. The components described above are sequentially disposed from bottom to the top. A plurality of liquid crystals 306 are disposed in the display screen 305. The display screen 305 is transparent display screen. A plurality of particles 304 are disposed in the light guide plate 301 and can reflect or scatter the light incident into the light guide plate 301. The particles 304 also can be reflective sheets, transparent silica particles, or other substances that can reflect or scatter light.

When a light 303 emitted from a light source is incident to the light guide plate 301, since the particles 304 are disposed in the light guide plate 301, the light is reflected as the light 303 arrives the particles 304. When the reflected light is incident to a first light exit surface of a through hole, the light is refracted through the first light exit surface, as the refracted light 3031. Then, the light enters the through hole area and propagates into the display screen 305. Therefore, the lights in the light guide plate 301 are guided to the first display area, which increases the display brightness of the through hole area and the first display area, and increases the display quality.

Specifically, as shown in FIG. 4, FIG. 4 is a schematic structure of a light guide plate according to an embodiment of the present disclosure. The first display area of the display panel is drilled. In an embodiment of the present disclosure, for guiding as more as possible lights into the through hole area in the first display area, the through hole is devised as a tapered hole when devising the light guide plate. In a cross-sectional view of the through hole, the end portion and the bottom of the through hole form an angle. The cross section of the first light exit surface is an inclined plane.

As shown in FIG. 4, FIG. 4 is a partial schematic structure of a light guide plate. The light guide plate 400 has an inclination angle, and the inclination angle is less than 90 degrees. After a light 401 emitted from a light source being incident to the light guide plate 400, the light 401 is reflected and refracted, as a light 403 exiting from the top surface of the light guide plate and a light 404 exiting from the first light exit surface. At the point a on the top surface of the light guide plate 400, a portion of light is refracted and enters the film layer above the light guide plate 400, and another portion of light is reflected several times, then incident to the first light exit surface, and is refracted on the first light exit surface to form a light 4031. The light 4031 enters the through hole area and is incident into the first display area. Therefore, more lights in the light guide plate 400 enter the display panel to increase the brightness of the display area. When the camera device in the first display area doesn't work, the first display area achieves a transparent display.

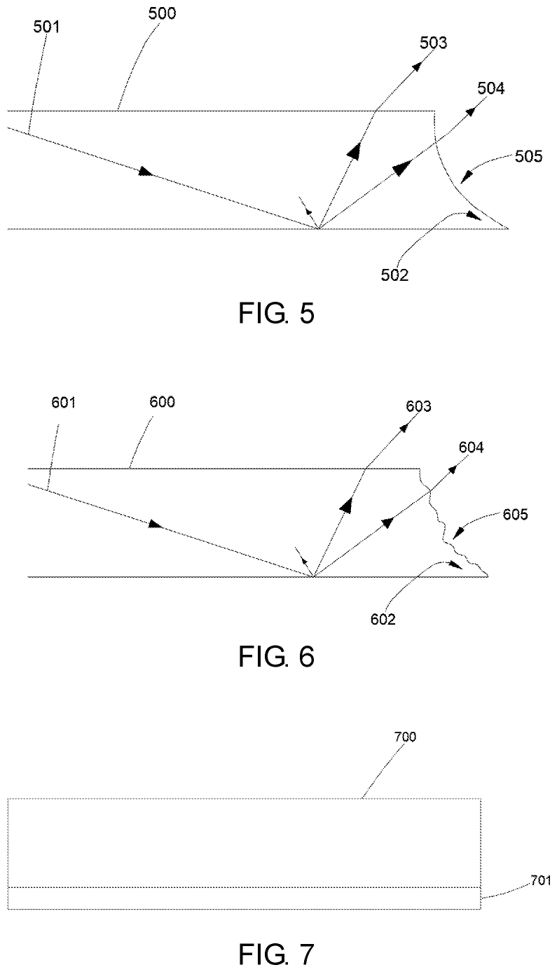

Preferably, as shown in FIG. 5, FIG. 5 is a schematic structure of a light guide plate according to another embodiment of the present disclosure. In an embodiment of the present disclosure, the shaped surface 505 of a light guide plate 500 is a quadric surface. The quadric surface curvatures along the side wall of the through hole are different from upper to bottom. The curvature of an upper end of the shaped surface 505 is greater than the curvature of a lower end of the shaped surface 505.

When a light 501 is incident to a light guide plate 500, through several times of reflection and a refraction, both a light 503 and a light 504 exiting from the shaped surface 505 can enter the through hole area and the first display area to increase the brightness of the first display area. When the camera device in the through hole area doesn't work, the through hole area achieves a transparent display.

Preferably, as shown in FIG. 6, FIG. 6 is a schematic structure of a light guide plate according to another embodiment of the present disclosure. In an embodiment of the present disclosure, a first light exit surface 605 of a light guide plate 600 is a free curved surface, namely, the shaped surface is a free curved surface. When devising the free curved surface, the free curved surface is devised as a convex-concave curved surface. Similarly, when a light 601 is incident to a light guide plate 600, the light 601 is reflected several times and refracted by the surface of the light guide plate 600 and the first light exit surface 605. Both an exiting light 603 and an exiting light 604 enter the through hole area and the first display area. The first light exit surface 605 is devised as a free curved surface. Therefore, lights are also reflected several times and refracted by the free curved surface, which makes as more as possible lights be guided into the first display area and ensures the brightness of the first display area. The angle 602 can be adjusted according to the size of the screen for modifying the brightness of the through hole area and ensuring the uniformity of the screen brightness.

An embodiment of the present disclosure further provides a display device. As shown in FIG. 7, FIG. 7 is a schematic diagram of a display device according to an embodiment of the present disclosure. The display device 700 includes a backlight module 701 according to an embodiment of the present disclosure. The backlight module 701 further includes a light guide plate according to an embodiment of the present disclosure.

The light guide plate, the backlight module, and the display device according to embodiments of the present disclosure are described in detail herein. The present disclosure has been described with a preferred embodiment thereof. The preferred embodiment is not intended to limit the present disclosure, and it is understood that many changes and modifications to the described embodiment can be carried out without departing from the scope and the spirit of the disclosure that is intended to be limited only by the appended claims.

What is claimed is:

1. A light guide plate, comprising:
a light guide body; and
a through hole disposed on the light guide body;
wherein the light guide body comprises a first light exit surface; the first light exit surface is a side wall surrounding the through hole, and the first light exit surface is a shaped surface;
wherein the shaped surface is a quadric surface, a curvature of an upper end of the quadric surface is greater than a curvature of a lower end of the quadric surface.

2. The light guide plate according to claim 1, wherein the through hole is a tapered hole, a cross section of the first light exit surface is an inclined plane.

3. The light guide plate according to claim 1, wherein the shaped surface is a free curved surface, the free curved surface is a convex-concave curved surface.

4. The light guide plate according to claim 1, further comprising a plurality of particles, wherein the particles are transparent silica particles; the particles are disposed in the light guide body.

5. The light guide plate according to claim 1, further comprising a camera device, wherein the camera device is disposed in the through hole.

6. The light guide plate according to claim 5, wherein a height of the camera device is not greater than a height of the through hole.

7. A light guide plate, comprising:
a light guide body; and
a through hole disposed on the light guide body;
wherein the light guide body comprises a first light exit surface, the first light exit surface is a side wall surrounding the through hole, and the first light exit surface is a shaped surface.

8. The light guide plate according to claim 7, wherein the through hole is a tapered hole, a cross section of the first light exit surface is an inclined plane.

9. The light guide plate according to claim 7, wherein the shaped surface is a free curved surface, the free curved surface is a convex-concave curved surface.

10. The light guide plate according to claim 7, wherein the shaped surface is a quadric surface, curvatures along the side wall of the quadric surface are different from upper to bottom.

11. The light guide plate according to claim 7, further comprising a plurality of particles, wherein the particles are transparent silica particles; the particles are disposed in the light guide body.

12. A backlight module, comprising:
a light guide plate, wherein the light guide plate comprises a light guide body and a through hole, the through hole is disposed on the light guide body;
an optical film disposed on the light guide plate;
a display screen disposed on the optical film;
a light source; and
a frame body, wherein the light source is disposed on a side of the frame body and used for providing a light source for the light guide plate, the frame body is disposed outside the light guide plate and for fixing the light guide plate;
wherein the light guide body comprises a first light exit surface, the first light exit surface is a side wall surrounding the through hole, and the first light exit surface is a shaped surface.

13. The backlight module according to claim 12, wherein the display screen comprises a first display area and a second display area, the first display area is disposed adjacent to the second display area, the through hole is disposed in the first display area.

14. The backlight module according to claim 12, further comprising a camera device, wherein the camera device is disposed in the through hole.

15. The backlight module according to claim 14, wherein a height of the camera device is not greater than a height of the through hole.

16. The backlight module according to claim 12, wherein the through hole is a tapered hole, a cross section of the first light exit surface is an inclined plane.

17. The backlight module according to claim 12, wherein the shaped surface is a free curved surface; the free curved surface is a convex-concave curved surface.

18. The backlight module according to claim 12, wherein the shaped surface is a quadric surface; curvatures along the side wall of the quadric surface are different from upper to bottom.

19. The backlight module according to claim 12, wherein the light guide plate further comprises a plurality of particles; the particles are transparent silica particles; the particles are disposed in the light guide body.
